(19) United States
(12) Patent Application Publication
(10) Pub. No.: US 2007/0023500 A1
(43) Pub. Date: Feb. 1, 2007

(54) NOTE VALIDATING AND STORAGE ASSEMBLY AND METHOD

(76) Inventors: Peter Wolfgang DeRaedt, Reno, NV (US); Bernd Witzany, Graz (AT); Ludo DeMeutter, Borsbeck (BE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/456,696

(22) Filed: Jul. 11, 2006

Related U.S. Application Data
(60) Provisional application No. 60/703,811, filed on Jul. 29, 2005.
(60) Provisional application No. 60/724,829, filed on Oct. 7, 2005.

(51) Int. Cl. G07F 19/00

(52) U.S. Cl. 235/379

(57) ABSTRACT

A note validating and storage assembly for a gaming table having a table top includes a storage box for storing notes received at the gaming table. A validator, adjacent the storage box, validates, authenticates and determines the value of the notes. A controller having a memory is in operative communication with the validator for receiving and storing data corresponding to the authenticity and value of the notes. A separator adjacent the validator grips one of the notes and separates it from a plurality of notes. A fan assembly is operably associated with the separator for aiding in separating the notes. A holding area is disposed below the table top such that notes may be pushed through a note entry slot in the table top and into the storage area with a plunger. An RFID system can be employed in conjunction with gaming chips for various table management purposes.

### CROSS-REFERENCE TO RELATED APPLICATION

The instant application claims priority to U.S. Provisional Patent Application Ser. No. 60/703,811, filed Jul. 29, 2005, and U.S. Provisional Patent Application Ser. No. 60/724,829, filed Oct. 7, 2005, the entire specifications of both of which are expressly incorporated herein by reference.

### FIELD OF THE INVENTION

The invention relates generally to gaming and more particularly to an assembly and method for receiving, validating, and storing notes and chips at a gaming table.

### BACKGROUND OF THE INVENTION

Casinos have long required that chips be used as the monetary instrument at gaming tables. Dealers must exchange currency from the player for chips to be used at the gaming table. The currency is typically pushed with a plunger down a slot in the gaming table into a secured cash box. The cash boxes at each gaming table are periodically switched out with the full boxes taken to a “count room” where the contents are counted. The exact value of the currency in the cash box is not known until after counting.

With an increasing desire for “real-time” accounting in casinos along with enhanced auditing standards, it is desirous to keep track of the exact value of currency and other notes in the cash box. Various systems and methods for tracking the value of notes in a cash box are known. Two such systems and methods are disclosed in U.S. Pat. No. 5,957,776 to Hoehne (the '776 patent) and U.S. Pat. No. 6,745,887 to Heidel et al. (the '887 patent).

The '776 patent discloses a gaming table tracking system which tracks the value of notes in a cash box. The system includes a table control unit and a plurality of pushbuttons in operative communication with the table control unit. When notes are received from a player, the dealer uses the pushbuttons to enter the position of the player and the value of the notes. The player position and value of the notes is stored in the table control unit. The notes are pushed into the cash box using a plunger. The system of the '776 patent has no ability to authenticate and determine the value of the notes. Furthermore, the system is subject to operator error with mispressed pushbuttons, resulting in a flawed accounting of the exact value of notes stored in the storage box.

The '887 patent discloses a note validator assembly for a gaming table. The assembly includes a bezel for holding a plurality of notes that are laid flat. A separator pulls a single note from the bezel. The single note is pulled into a bill discriminator that determines the authenticity and the value of the note. Valid notes are routed to a cash box while invalid notes are sent to a reject slot. The bezel, separator, and bill discriminator are disposed above a table top of the gaming table. This results in a bulky apparatus occupying valuable space on the table top and is not suitable for dice games, such as craps, and other games where the secure cashbox is installed away from an edge of the table. Furthermore, because the notes are laid flat on the bezel above the table top, it is a difficult variation from the traditional procedure of pushing the notes down a slot in order to get the notes away from the table surface as quickly as possible. This traditional procedure is used at virtually all casino gaming tables.

The present invention is aimed at one or more of the problems identified above.

### SUMMARY OF THE INVENTION

In accordance with the general teachings of the present invention, new and improved assemblies and methods for receiving, validating, and storing notes and chips at a gaming table are provided.

In accordance with a first embodiment of the present invention, a note validating and storage assembly for a gaming table is provided, comprising: (1) a storage box for storing notes received at the gaming table, each note having an associated value; (2) a validator disposed adjacent to the storage box for validating the authenticity of the notes and determining the value of the notes; (3) a separator apparatus disposed adjacent to the validator for separating the notes; (4) a holding area operatively connected to the separator and configured for temporarily holding at least one note in a folded configuration; and (5) a fan assembly operably associated with the separator apparatus.

In accordance with a first alternative embodiment of the present invention, a chip validating and storage assembly for a gaming table is provided, comprising: (1) a storage box for storing chips received at the gaming table, each chip having an associated value; (2) a validator disposed adjacent to the storage box for validating the authenticity of the chips and determining the value of the chips; and (3) a radio frequency identification system operably associated with the chip.

In accordance with a second alternative embodiment of the present invention, a note and chip validating and storage assembly for a gaming table is provided, comprising: (1) a storage box system for storing notes and chips received at the gaming table, each note and chip having an associated value; (2) a validator disposed adjacent to the storage box system for validating the authenticity of the notes and chips and determining the value of the notes and chips; (3) a separator apparatus disposed adjacent to the validator for separating the notes; (4) a holding area operatively connected to the separator and configured for temporarily holding at least one note in a folded configuration; (5) a fan assembly operably associated with the separator apparatus; and (6) a radio frequency identification system operably associated with the chip.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a note validation and storage assembly showing a storage box and an enclosure disposed below a table top of a gaming table;

FIG. 2 is a block diagram showing the components of the assembly in one embodiment;

FIG. 3 is a block diagram showing the components of the assembly in a more detailed embodiment;

FIG. 4 is a side view of one embodiment of a separator apparatus showing the separation of a single note from a plurality of notes in a holding area;

FIG. 5 is a side view of one embodiment of the separator apparatus showing the retention of the plurality of notes in the holding area while the single note is transferred to a transport mechanism;

FIG. 6 is a top view of a user interface;

FIG. 7 is a partial cross-sectional side view of a plunger lighting system;

FIG. 8 is a schematic drawing of a note validation and storage assembly, according to another embodiment of the present invention;

FIG. 9 is a diagrammatic illustration of a fan assembly of the note validation and storage assembly of FIG. 8;

FIG. 10 is a simplified illustration of a top of the note validation and storage assembly of FIG. 8; and

FIGS. 11a-d are schematic illustrations of an alternative lighting/message system for use with the note validation and storage assembly of either FIGS. 3 and/or 8.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

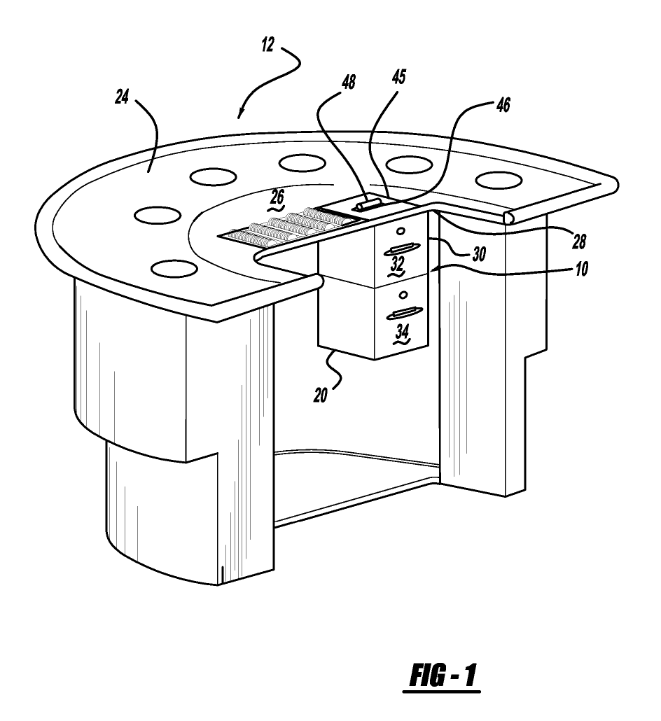

Referring to the Figures, wherein like numerals indicate corresponding parts throughout the several views, a note validating and storage assembly 10 for a gaming table 12 is shown in FIG. 1. By “note,” as that term is used herein, it is meant to include any indicia of value or cash, and can include without limitation, notes, currency, cash, coins, chips, markers, coupons, tickets, and/or the like. The gaming table 12 as shown in FIG. 1 denotes a card game style table as is commonly used in Blackjack and/or the like. However, the assembly 10 may also be implemented in other style gaming tables 12, including, but not limited to a craps table or a roulette table.

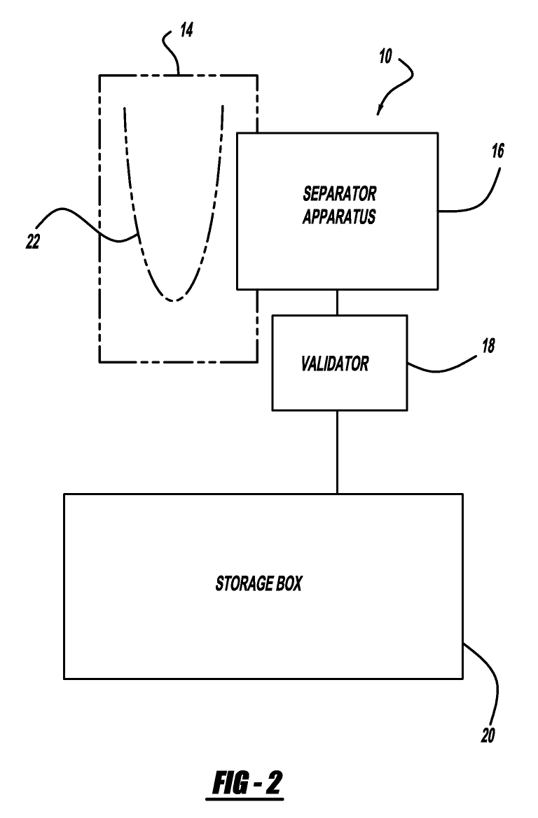

Referring to FIG. 2, in one embodiment, the assembly 10 includes a holding area 14, a separator apparatus 16, a validator 18, and a storage box 20. The holding area 14 temporarily holds at least one note 22 received at the gaming table 12, where each note 22 has an associated value. These notes 22 include, but are not limited to, paper currency, markers, chip fill and credit slips, coupons, gaming machine tickets, or other paper instruments that denote or have an associated value or are used to assist in management related functions. The assembly 10 may be adapted to handle the currency from multiple countries and may be configured to handle multiple currencies at the same time or only one at a time. The holding area 14 is configured to hold the at least one note 22 in a folded configuration.

The separator apparatus 16 is disposed adjacent to the holding area 14. The separator apparatus 16 separates the notes 22 temporarily held in the holding area 14. A validator 18 is disposed adjacent to the separator apparatus 16. The validator 18 validates the authenticity of the notes 22 and determines the value or a unique identifier (e.g., in the case of paper instruments other than paper currency) of the notes 22. The storage box 20 is operatively connected to the validator 18. The storage box 20 stores the notes 22 received at the gaming table 12 after the notes 22 pass through the validator 18.

Referring again to FIG. 1, the gaming table 12 includes a table top 24. The table top 24 includes an upper surface 26 where the game is played and a lower surface 28 generally inaccessible by game players. A bracket (not shown) is operatively connected to the lower surface 28. In one embodiment, the assembly 10 includes an enclosure 30 disposed below and supported by the bracket. The holding area 14, separator apparatus 16, and validator 18 are disposed within the enclosure 30. The enclosure 30 includes an enclosure door 32 for accessing the contents of the enclosure 30. The enclosure door 32 includes at least one locking mechanism for securing the enclosure door 32 in a closed position. The enclosure 30 is removably attachable (i.e., separable) from the bracket. This allows for quick replacement of the enclosure 30 in case of a failure of the components therein. The enclosure 30 can also be replaced with a standard cashbox as used in the casino property.

The storage box 20 includes a storage box door 34 for accessing the contents of the storage box 20. The storage box door 34 includes at least one locking mechanism for securing the storage box door 34 in a closed position. In one embodiment, the storage box 20 is disposed below and supported by the enclosure 30. The storage box 20 is removably attachable (i.e., separable) from the enclosure 30 such that the storage box 20 can be transported away from the gaming table 12 (i.e., for removal of the contents) and a replacement storage box 20 substituted in its place.

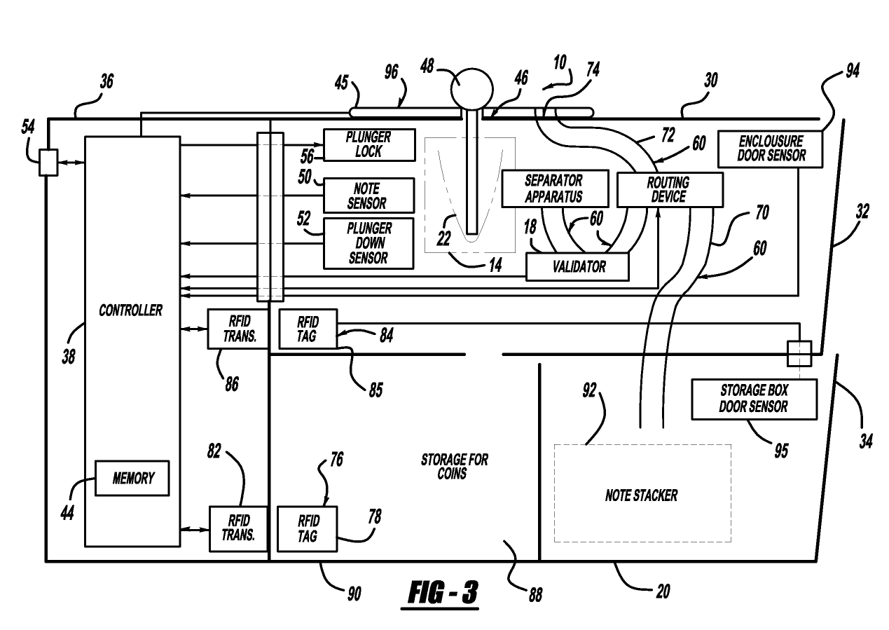

Referring now to FIG. 3, which shows a more detailed embodiment, the assembly 10 includes an electronics compartment 36. The electronics compartment 36 is disposed adjacent to the storage box 20 and the enclosure 30. The electronics compartment 36 is disposed below and supported by the bracket. The electronics compartment 36 is removably attachable (i.e., separable) from the bracket.

A controller 38 is disposed within the electronics compartment 36. The controller 38 may include a microprocessor, a microcontroller, an application specific integrated circuit (ASIC), and/or other suitable device as is well known to those skilled in the art. The controller 38 functions to control various components of the assembly 10 as described in further detail below. Of course, much of the control and interaction between the components may be accomplished without the use of the controller 38. The controller 38 also includes a main memory 44 for storing data. The main memory 44, however, may be separate from but in operative communication with the controller 38.

In one embodiment, a face plate 45 is disposed on the upper surface 26 of the table top 24. The table top 24 and face plate 45 define a note entry slot 46 for receiving at least one note 22. Typically, the dealer will place the note 22 or notes 22 centered atop the note entry slot 46. A plunger 48 may be used to push the note 22 or notes 22 through the note entry slot 46. By this action, the note 22 or notes 22 become folded generally in half.

The holding area 14 is disposed below the note entry slot 46. The holding area 14 temporarily holds the at least one note 22 pushed through the note entry slot 46 with the plunger 48 in a folded configuration. The enclosure 30 defines a hole disposed between the note entry slot 46 and the holding area 14. The plunger 48, while inserted into the holding area 14, also serves to retain the at least one note 22 in the folded configuration.

A note sensor 50 is disposed within the enclosure 30 and adjacent to the holding area 14. The note sensor 50 is electrically connected to the controller 38 and senses at least one note 22 in the holding area 14. A plunger down sensor 52 is also disposed within the enclosure 30 and adjacent to the holding area 14. The plunger down sensor 52 is electrically connected to the controller 38 to sense that the plunger 48 is fully inserted into the holding area 14. The note sensor 50 and plunger down sensor 52 may be implemented as optical or capacitive type-sensors or any other appropriate sensor as known to those skilled in the art.

A plunger lock 56 is disposed within the enclosure 30 and adjacent to the holding area 14. In one embodiment, the plunger lock 56 is electrically connected to the controller 38 and in operative communication with the note sensor 50 and the plunger down sensor 52. The plunger lock 56 will lock the plunger 48 in place in response to the note sensor 50 sensing at least one note 22 in the holding area 14 and the plunger down sensor 52 sensing that the plunger 48 is fully inserted into the holding area 14. In other embodiments, the plunger lock 56 may be configured to lock the plunger 48 based on other events, which are configurable in the controller 38.

Once the plunger 48 is locked in place, the separator apparatus 16 grips a single note 58 and separates the single note 58 from the other notes 22 being temporarily held in the holding area 14.

The validator 18 is in operative communication with the controller 38. The validator 18 validates the authenticity of the single note 58 and determines the value of the single note 58. Validators of this type are well known to those skilled in the art and typically involve optical scanners including lasers, light emitting diodes (LEDs), and/or optical sensors for validating the single note 58. Data relating to the authenticity of the note 22 and the value of the note 22 is communicated to the controller 38 for storage and analysis. The validator is capable of reading bar codes or other optically-read messages. Accordingly, if the note 22 includes a bar code or other optically-read message, data relating to the bar code or message may also be communicated to the controller 38.

A transport mechanism 60 is operatively connected to the separator apparatus 16 and the validator 18. The transport mechanism 60 moves the note 22 from the separator apparatus 16 and through the validator 18. Transport mechanisms 60 are well known in the art and typically involve a plurality of rollers 62 powered by motors.

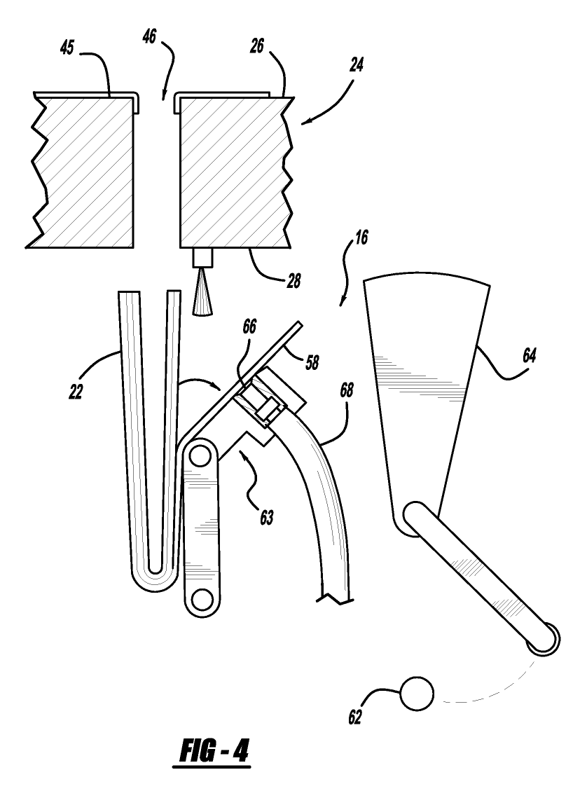

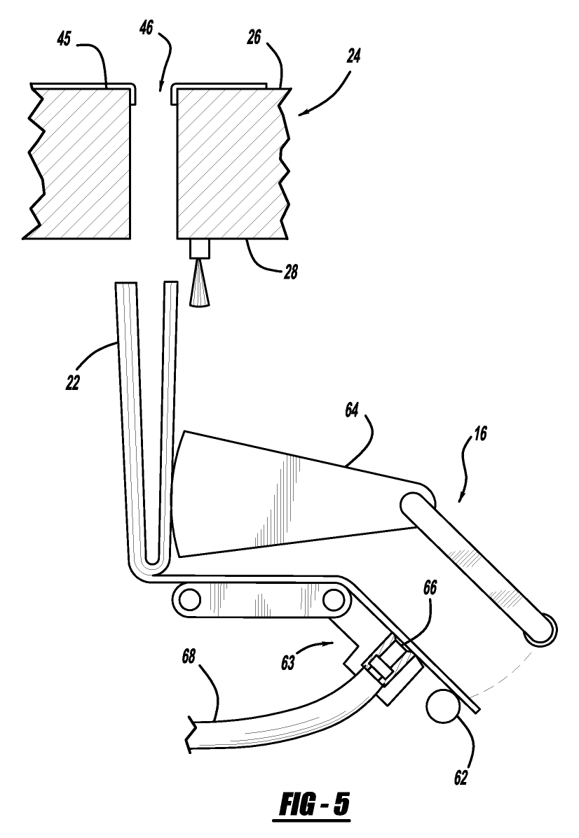

Referring now to FIGS. 4 and 5, in one embodiment, the separator apparatus 16 includes a suction device 63 and a retainer 64. The suction device 63 may include a suction cup 66 and a vacuum line 68 disposed in the center of the suction cup 66 for gripping a note. To separate a single note 58 from the plurality of notes 22 in the holding area 14, the suction device 63 is positioned such that the suction cup 66 is disposed against notes 22. A vacuum is then applied to the vacuum line 68 which pulls a single note 58 toward the suction cup 66. As shown in FIG. 4, the suction device 63 then maneuvers away from the plurality of notes 22; thus separating the single note 58 away from the remaining notes 22. Meanwhile, as shown in FIG. 5, the retainer 64 moves against the remaining notes 22 to retain them in the holding area 14. The single note 58 is placed against one of the rollers 62 of the transport mechanism 60. The transport mechanism 60 then pulls the single note 58 out of the holding area 14 and through the validator 18.

Referring again to FIG. 3, the transport mechanism 60 defines two separate paths for the notes 22 after they pass through the validator 18. A first path 70 routes the notes 22 to the storage box 20 and a second path 72 routes notes 22 to a reject slot 74. The outlet is formed by holes in the table top 24 and the enclosure 30. Typically, notes 22 that are determined authentic by the validator 18 travel along the first path 70 for storage in the storage box 20. Notes 22 that are determined unauthentic travel along the second path 72 to be returned to the dealer via the reject slot 74. However, there may be instances where unauthentic notes 22 travel to the storage box 20.

The transport mechanism 60 includes a routing device 42. The routing device 42 is electrically connected to the controller 38 and in operative communication with the validator 18. The routing device 42 selects between the first path 70 and the second path 72 in response to the authenticity of the note 22 from the validator 18. A solenoid (not shown) may be used to physically change the position of the rollers 62 of the transport mechanism 60 in order to select the appropriate path 70, 72.

The assembly 10 further includes a first transportable memory 76 operatively connected to the storage box 20. The first transportable memory 76 contains a unique identification code for uniquely identifying the storage box 20. The first transportable memory 76 is in operative communication with the controller 38. The value of the notes 22 stored in the storage box 20 is recorded in the first transportable memory 76. The first transportable memory 76 may also record information such as, but not limited to, the total of notes per denomination, the notes provided by identified players, and various management and performance information.

In one embodiment, the first transportable memory 76 may be further defined as a first radio frequency identification (RFID) tag 78, 85 attached to the storage box 20. A first RFID transceiver 82 is attached to the electronics compartment 36 and positioned adjacent the first RFID tag 78. The first RFID transceiver 82 is electrically connected to and in operative communication with the controller 38. The first RFID transceiver 82 reads and writes data to the first RFID tag 78 as directed by the controller 38.

A second transportable memory 84 is operatively connected to the enclosure 30. The second transportable memory 84 contains a unique identification code for uniquely identifying the enclosure 30. The second transportable memory 84 is also in operative communication with the controller 38. Other data, such as the value of the notes 22 passing through the enclosure 30, number of notes 22 validated, and so forth may be recorded in the second transportable memory 84.

As with the first transportable memory 76, in one embodiment, the second transportable memory 84 may be further defined as a second RFID tag 85 attached to the enclosure 30. A second RFID transceiver 86 is attached to the electronics compartment 36 and positioned adjacent the second RFID tag 85. The second RFID transceiver 86 is electrically connected to and in operative communication with the controller 38 for reading and writing data to the second RFID tag 85 as directed by the controller 38.

In one embodiment the storage box 20 is divided into a first compartment 88 and a second compartment 90. The first compartment 88 includes at least one note stacker 92 for storing notes 22. An acceptable note stacker 92 is manufactured by JCM American Corporation headquartered in Las Vegas, Nev. Multiple note stackers 92 may be disposed within the first compartment 88 and used to separate paper currency from other types of notes 22 or to separate authentic notes 22 from unauthentic notes 22. The second compartment 90 may be used to store non-paper instruments that denote a value, such as coins or casino chips.

Of course, the storage box 20 may be divided and configured in other ways, depending on particular needs of a casino. The assembly 10 further includes an enclosure door sensor 94 and a storage box door sensor 95 for sensing the position of the enclosure door 32 and the storage box door 34, respectively. The door sensors 94, 95 are electrically connected to and in operative communication with the controller 38.

The assembly 10 also includes at least one communication port 54 in operative communication with the controller 38 for exchanging information with a network, a central server, a personal digital assistant (PDA) or other devices as are well known to those skilled in the art. The at least one communication port 54 may include an Ethernet port, a serial port, a radio frequency (RF) port, and/or and infrared (IR) port or other wireless device.

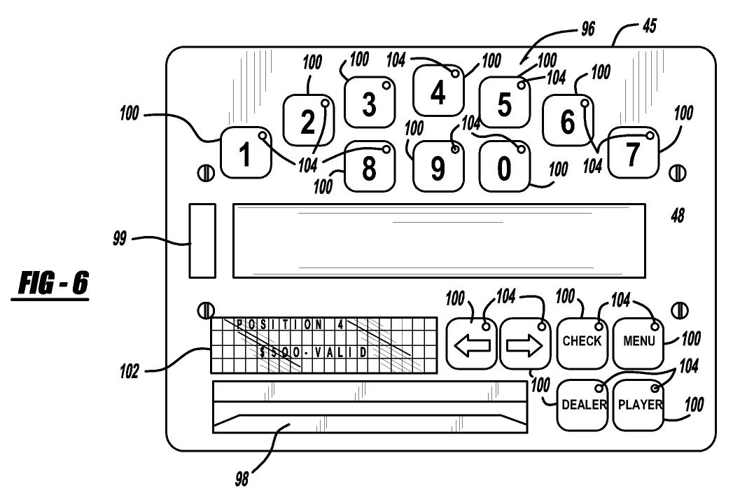

Referring now to FIG. 6, the assembly 10 further includes a user interface 96. The user interface 96 is in operative communication with the controller 38 for allowing a user to communicate with the controller 38. In one embodiment, the user interface 96 is integrated with the face plate 45, which is disposed on the upper surface 26 of the table top 24.

The user interface 96 may includes a card reader 98 for reading an identification card. In one embodiment, the card reader 98 is a magnetic-stripe card reader 98. However, the card reader 98 could also be implemented as a bar code reader, a smart card reader, an RFID reader, or any other type of reading device known to those skilled in the art.

The card reader 98 may also be used to identify the dealer. When taking over or relinquishing operation of the gaming table 12, the dealer swipes his or her identification card to log in or log out. The date, time, and identity of the dealer may then be stored in the memory 44 of the controller 38.

The user interface 96 further includes a plurality of pushbuttons 100 for entering data. The plurality of pushbuttons 100 include ten numeric pushbuttons 100 numbered between 0 and 9. A portion of the numeric pushbuttons 100 are arranged to mirror player positions at the gaming table 12. For example, as shown in FIG. 6, the numeric pushbuttons 100 numbered 1 through 7 are arranged in a semicircular pattern that corresponds to seven player positions at the gaming table 12. However, it should be readily appreciated that the pattern and/or number of player positions is dependent on the game type.

The invention can be utilized to provide a method of tracking a value of notes 22 received from a player. First, the identity of the player is determined. In one embodiment, the player would hand an identification card to the dealer, such as a casino-issued “player's club” type card. The dealer would utilize the card reader 98 to read an identification number and/or other data off the card. The dealer may also record the position of the player by pressing the appropriate pushbutton 100. The controller 38 then records the identity and playing position of the player.

The dealer receives at least one note 22 from the player. The at least one note 22 is pushed into the holding area 14 with the plunger 48. The assembly 10 then automatically determines the value of the at least one note 22. The value of the at least one note 22 is then recorded by the controller 38. The value of the at least one note 22 is associated with the identity of the player. Subsequent notes accepted by the dealer from the player can be associated with the identity of the player without using the identification card, but by the dealer simply pressing the position of the player with the appropriate pushbutton 100.

The user interface 96 also includes a display 102 for displaying information to a user, such as the dealer. This information may include, but is not limited to, instructions to the user, a value of the current or previous note drop, the value of notes for a particular player, and the value of notes in the stored in the storage box. In one embodiment, the display 102 may be a liquid crystal display 102 (e.g., LCD) or any other display as is known in the art. The user interface also includes a plurality of indicating lights 104. Each indicating light 104 may be associated with one of the pushbuttons. The indicating lights may be LEDs and are utilized to convey information to the user.

In one embodiment, the user interface 96 may also include a biometric reader (not shown) for determining the identity of the user. The biometric reader is in operative communication with the controller. The biometric reader may sense fingerprint patterns or other unique biometric characteristics.

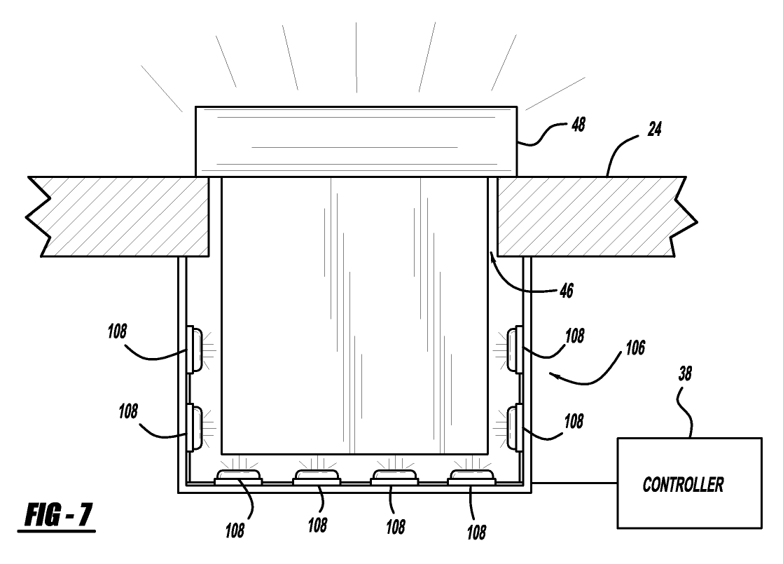

Referring to FIG. 7, in one embodiment, the assembly 10 may also include a plunger lighting system 106 in operative communication with the controller 38 to deliver status information to the user. The plunger 48 is formed of a transparent material, such as a plastic, and includes a handle that is sized larger than the note entry slot 46, such that the handle remains above the table top 24. The plunger lighting system includes at least one light source 108 supported within the enclosure 30 and positioned adjacent to the plunger 48. The positioning of the at least one light source 108 coupled with the transparency of the plunger 48 allows for the handle to illuminate, thus delivering status information. Such status information may include, but is not limited to, normal operation of the system, system failure, the drop box 20 nearing or being at capacity, or the detection of an unauthentic note 22. The light source 108 may be a bi-color LED, an incandescent light, or other lighting source as are known to those skilled in the art.

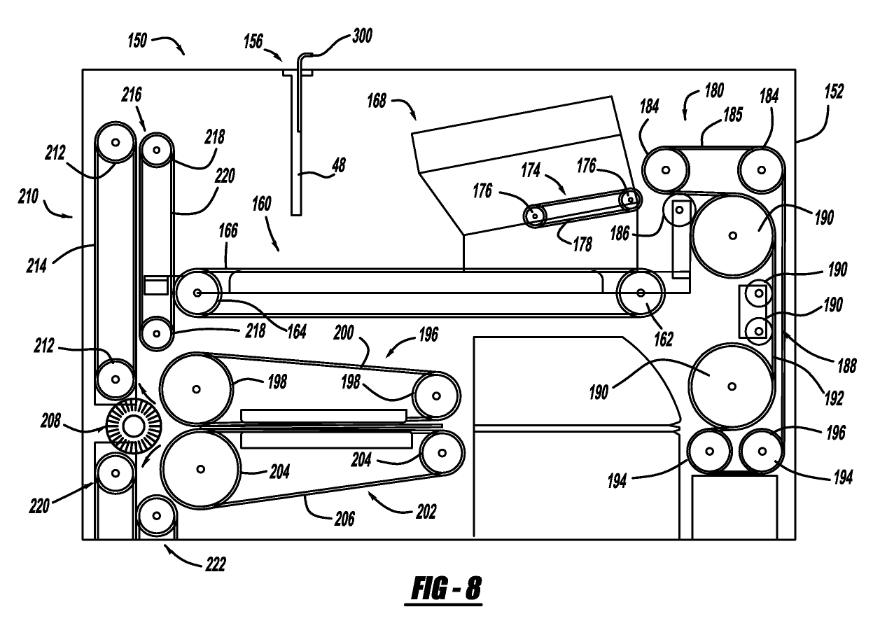

With reference to FIGS. 8-10, a second note validating and storage assembly 150, according to another embodiment of the present invention is disclosed. The storage assembly 150 can include a user interface, e.g., one substantially as shown and described in connection with FIG. 6 of the previously described embodiment of storage assembly 10.

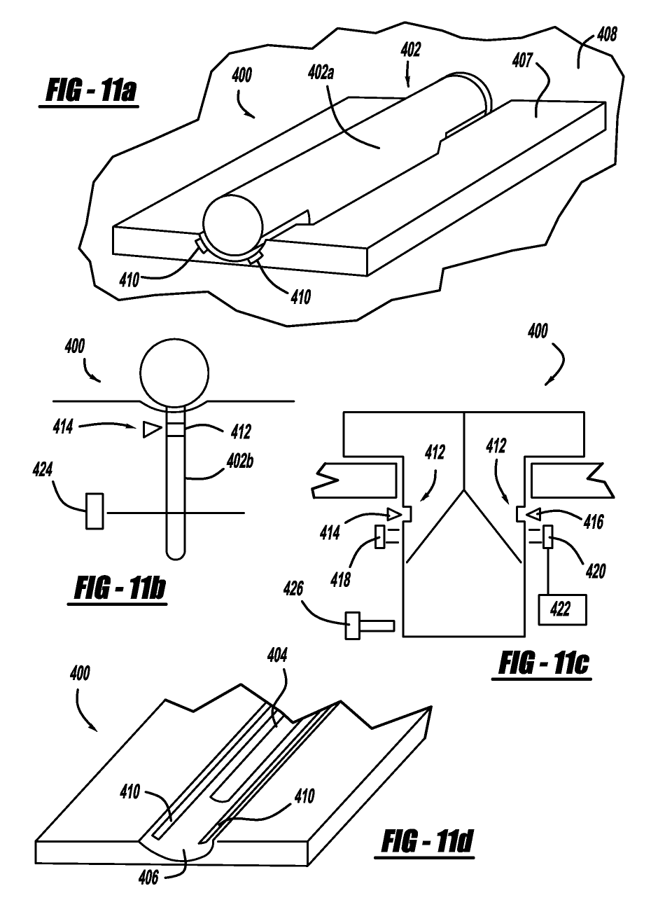

The assembly 150 includes a box or housing 152 having a top 154 (see FIG. 10), which is adapted to receive one or more notes 22 through a slot 156 in a folded configuration. The notes may be inserted and pushed through the slot via the plunger 48 as described above. The top 154 may also include an exit slot 158 (see FIG. 10) for release or exiting of fraudulent or rejected notes 22 (e.g., see below).

The assembly 150 includes a first conveyor 160. After the notes 22 are inserted into the assembly 150, the notes fall and open onto the first conveyor 160. An assist device (not shown) may be used to assist the notes 22 in opening into a flat position upon the first conveyor 160. The first conveyor 160 includes at least one motorized rotating elements or driven wheel 162, at least one non-driven wheel 164 and a rubber belt 166 located about the wheels 162, 164 and rotated by the at least one driven wheel 162. The driven wheel 162 is rotated at an adjustable speed via a motor (not shown).

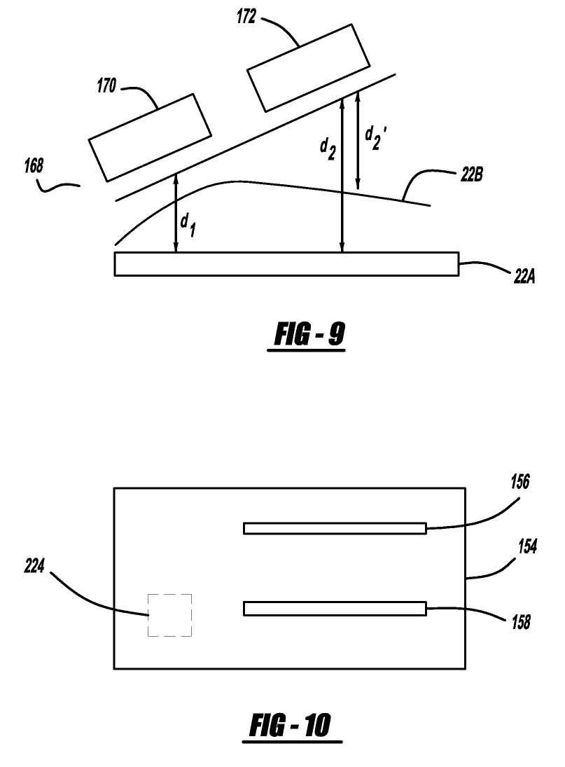

Typically the notes 22 (if more than one note 22 is inserted at the same time) are in a stack 22A (see FIG. 9), and as a stack 22A are moved by the first conveyor 160 in a direction from left to right in FIG. 8.

As shown in FIG. 9, the assembly 150 includes a fan assembly 168 that includes at least one fan. In the illustrated embodiment, the fan assembly 168 includes first and second fans 170, 172 that move air in a direction away from the stack of notes 22A on the first conveyor 160. In the illustrated embodiment, the fan assembly 162 is angled such that the first end is closer to the first conveyor 154 than the opposite end.

The fans 170, 172 provide a flow of air towards the fan assembly 168. Distance d₁ represents the distance between the fan assembly 168 and the top of the stack of notes 22A at the first end (assuming no lifting of the first note 22B). Likewise, distance d₂ represents the distance between the fan assembly 168 and the top of the stack of notes 22A at the opposite end. Because the first fan 170 is closer to the stack of notes 22A, the flow of air created by the first fan 170 tends to have a greater effect on the top note 22B than the second fan 172. As shown, the first fan 170 lifts a portion of the top note 22B toward the fan assembly 168, thus reducing the distance between the first note 22B and the opposite end of the fan assembly 168.

In the illustrated embodiment, the first fan 170 is located at the first end of the fan assembly 168 and the second fan 172 is located at the second end of the fan assembly 168. The width of the first and second fans will generally by less than the width of the smallest note that may be placed within assembly 150.

Returning to FIG. 8, the fan assembly 168 includes a second conveyor 174 located at a bottom end of the fan assembly 162. The second conveyor 174 includes a set of rotating elements 176, at least one of which is motorized, and a rubber belt 178 located about and rotated by the second set of rotating elements 176. The fans 170, 172 draw air in a direction from the first conveyor 160 towards the fan assembly 168. The air flow lifts and separates the notes 22 by lifting a top one of the notes 22B from the stack of notes 22A on the first conveyor 160. In one embodiment, the first fan 170 lifts a generally central portion of the top note 22B; thereby bringing a front portion of the note 22B closer to the second fan 172, which raises the note 22B into contact with the second conveyor 174.

When the lifted note 22B comes into contact with the second conveyor 174, the second conveyor 174 moves the lifted note 22B in a direction towards a routing mechanism 180.

The assembly 150 includes a validator 18, as described above. The routing mechanism 180 routes the notes 22 from the fan assembly 168 to the validator 18. In the illustrated embodiment, the routing mechanism 180 turns the direction of travel of the notes, as they pass through the routing mechanism 180, 180 degrees.

In the illustrated embodiment, the routing mechanism 180 includes a third conveyor 182. The third conveyor 182 includes a set of rotating elements 184, at least one of which is motorized, and a rubber belt 185 located about and rotated by the third set of motorized rotating elements 172. The notes 22 pass between the rubber belt 185 and a non-motorized wheel 186. The notes 22 are then passed along a fourth conveyor 188. The fourth conveyor 188 includes a set of rotating elements or wheels 190 (at least one of which is motorized) and a rubber belt 192 located about the wheels 190 and rotated by the motorized wheel 190. At the end of the fourth conveyor 188, the individual notes 22 are passed between the rubber belt 192 and a set of rollers 194 and a rubber belt 196 and into the validator 18. In the illustrated embodiment, the validator 18 receives the individual notes 22, reads or validates the notes 22, as described above, and passes the notes through fifth and sixth conveyors 196, 202. In the illustrated embodiment, the validator 18 is motorized and passes the notes 22 therethrough.

The fifth conveyor 196 includes a set of rotating elements or wheels 198 and a rubber belt 200 located about the set of rotating elements or wheels 198. The sixth conveyor 202 includes a set of rotating elements 204 and a rubber belt 206, located about the set of rotating elements or wheels 204. At least one of the wheels 204 of the sixth conveyor 202 is motorized. It should be noted that conveyors 196, 202, are closer together at the back end (e.g., in proximity to wheels 198, 204) than at the front end (e.g., in proximity to wheels 198, 204). This is to ensure that the notes are properly grabbed when they come out of the note reader and to avoid speed synchronization differences. That is, the notes are pulled from the note reader instead of being pushed by the note reader.

A selector 208, under control of the controller 38, is comprised of a sprocket wheel that continuously rotates in the direction of the notes need to be guided towards, e.g., to the exit slot or the storage container. Using a sprocket wheel to divert/guide the notes in the right direction is very effective. For example, the edge of the note/paper will hit between the sprockets and as the wheel continuously rotates, the notes are guided efficiently in the direction of the rotation. For example, the notes 22, which passed through the validator 18, and the fifth and sixth conveyors 196, 202, are passed via a seventh conveyor 210 and an eighth conveyor 216 through an exit slot (e.g., similar to exit slot 74 shown in FIG. 3) located at the top of the box 152. The seventh conveyor 210 includes a set of rotating element 212, at least one of which is motorized, and a rubber belt 214, located about the rotating elements 212, and being driven by the motorized rotating element 212. The eighth conveyor 216 includes a set of rotating elements to 218 and a rubber belt 220 located about the rotating elements 218. The eighth conveyor 210 may be motorized or not motorized. By way of another example, the notes 22, which pass through the validator 18 and the fifth and sixth conveyors 196, 202 are passed via a ninth conveyor 220 and a tenth conveyor 222 to the storage box 20. The ninth and tenth conveyors 220, 222, at least one of which is motorized, are partially shown in FIG. 8.

The dimensions and parameters of the notes are controllable through the controller 38 and may be adjusted based, for example, on the size, i.e., width and length of the notes 22 which may be used for a particular implementation or application. For example, the speed of the motorized conveyors may be adjusted and will be determined based on the length of the notes 22 being used and the speed at which the validator 18 passes and reads the notes 22. Additionally, the size and speed of the fans in the fan assembly may also be determined as a function of the different notes that may be used with the assembly 150.

Generally, the validator 18 reads the individual notes 22 and determines a value associated therewith. The value associated with the note may be passed to the controller 38 (see above). If the validator 18 cannot read the notes 22 or determines that the note is fraudulent, this information may also be passed to the controller 38, and/or up to a system connected to the controller 38 through the communication/network port 54.

In one embodiment, the assembly 150 may determine a measure of fitness for one or more of the notes. For example, the validator 18 may be able to determine the presence of wear and/or tears relative to individual notes. This information may be used to determine a fitness value for each note. A minimum fitness value may be set, for example, remotely, by a user at a remote computer connected or networked to the assembly 150. Any note having a fitness value less than the minimum fitness value may be rejected.

In another aspect of the present invention, multiple note stackers or storage boxes 20 may be provided. Once a box 20 becomes full, another box may be manually or automatically switched into place.

In one aspect of the present invention, the data received from the assembly 150 may be relayed back to the central server or other computer. The central server may be associated with a player tracking system. The patron or player swipes their card through the card reader 98. The data received from the assembly 150 with respect to the notes 22 received from a player is transmitted to the central server and may be associated with the player from whom the notes 22 were received. The central server or player tracking server, may thus, track which player attempts to pass fraudulent, otherwise unreadable notes 22, large sums of notes, large sums of a particular denomination, or other predetermined triggers. The central server may signal the dealer through the messaging system (e.g., see FIGS. 7 and 11) that a user has repeatedly or consistently attempted to pass fraudulent or unreadable notes. The central server may also signal and/or send specific messages to other systems such as security (e.g., CCTV and/or the like), such that, additional action may be taken, e.g., the table or player may be monitored more closely.

In one embodiment, the notes 22 are handled on an individual basis. For example, the validator 18 reads each note 22 and if read successfully, the notes 22 are dropped into the box 20. If the note 22 is fraudulent or otherwise unreadable, it may be fed or rejected through the exit slot 158 (e.g., see above). The dealer may then be notified of the status of the rejected bill via the messaging system (e.g., see above). The dealer may then decide to accept the rejected note 22 by re-inserting the note 22 and actuating an accept input 224. The accept input 224 may be a button (e.g., mechanical, touch and/or the like) or may be any sort of suitable input, such as a fingerprint sensor, Hall Effect or magnetic sensor or a proximity sensor which may require the passing of a token (not shown) in close proximity to the accept input 224.

In another embodiment, the notes 22 in a stack may be retained in an escrow device (not shown) and accepted or rejected as a whole. For example, if any one note is not acceptable, the entire stack may be rejected. The dealer may then be given the opportunity to accept the stack as described above.

In another aspect of the present invention, the assembly 150 may be adapted to receive other items, such as chips. It is not desirable that these other items are processed in the same manner as the notes 22. Thus, the assembly 150 may include a bypass mechanism consisting of a spring-loaded diverter 300 which in the absence of the paddle 48 diverts items dropped through the slot 156 directly into the box 20. It should also be appreciated that such a spring-loaded diverter can also be incorporated into the embodiment described in connection with assembly 10.

Once money has been collected using the above system, the next step is the handling of the money in the count room. Here, manual handling is still the norm, i.e., opening the storage box 20 (i.e., the cash box), taking the money to sorting machines, wrapping it, moving it to trays and so forth. It is the opening of all the boxes and the separation of paper, tokens, coins and money that takes not only time, it also requires strict procedures.

In another aspect of the present invention, the cash box 20 can be inserted in an automatic note separator device. This will drastically reduce the manual handling of the money. When the box 20 is inserted into the note separator device, the notes are automatically retrieved and separated. Additionally, the content of the RFID memory that is part of box 20 is downloaded by the note separator device. In the case the separator is capable of reading notes as well; an automatic comparison is made at the end of the separation. A signal (e.g., light or otherwise) will indicate if a discrepancy exists.

In one embodiment, the identification of the person that places the box 20 into the separator is automatically recorded. All count room personal can wear RFID tags, magnetic-stripe cards or any other method of identification including the use of biometrics.

The identification can also be recorded by requesting the person to use a pre-recorded biometrical identification every time a box 20 is placed into the separator as a trigger to start the operation. This guarantees who handled box 20 and also triggers the automatic opening of box 20. In one aspect of the present invention, the assembly 10, 150 may be configured remotely, for example, at the central server. For example, the following may be configurable: different fitness levels, including a minimum fitness level, and reject objections (e.g., single note or batch). Additionally, it should be appreciated that the return of any particular note or groups of notes can be for various reasons, including but not limited to: they are determined unauthentic by the validator; they are determined to be not fit enough by the validator; they are rejected by the dealer; they are rejected by a remote system, they are rejected by a local controller; and combinations thereof.

In another aspect of the present invention, firmware for operation of the controller 38 may be uploaded and stored in memory remotely, for example, via the central server.

Referring again to FIG. 3, and in still another aspect of the present invention, the storage assembly 10 is operable to store, read, and count chips C embedded with RFID tags RT. It is also envisioned that the present invention can be practiced with any type of currency, note, cash, coin, chip, marker, coupon, ticket, and/or the like, that can be provided with an RFID tag, and thus is not limited to the use of chips alone, which will be described herein for illustrative purposes only. As discussed above, chips C deposited into the storage assembly 10 may be separated and stored within box 20 or in the second compartment 90. Typically, the RFID tag RT of each chip C may include a value associated with the chip C. The RFID tag RT may also include additional information, e.g., an indication of an associated casino and/or other information. As one or more chips C with embedded RFID tags RT are deposited into the assembly 10 and stored in the second compartment 90, the RFID tag RT is read by the RFID reader or transceiver 82 or another RFID reader (not shown). For example, a separate RFID chip reader can be incorporated into the chip/coin entry slot. The value associated with each RFID embedded chip is read and transmitted to the controller 38. The controller 38 tabulates the chips, and the values associated therewith, stored in the second compartment 90. The information may be passed to the central server or other computer. The information may also be sent to and written on the first RFID tag 78, 85 located on the storage box 20. It should be appreciated that such a chip/RFID tag system may also be incorporated into the embodiment described in connection with storage assembly 150.

Referring to FIGS. 11a-d, there are shown schematic illustrations of an alternative lighting/message system 400 for use with the note validation and storage assembly 10, 150 of either FIGS. 3 and/or 8. The system 400 includes a plunger 402 operable to access a slot 404 formed in a recessed and curved surface 406 of a face plate portion 407, such as one that would be mounted to a table top 408 (e.g., of a gaming table) in order to deposit notes therein for processing by the storage systems of the present invention, as previously described. Also formed on the curved surface 406 is at least one and more preferably a plurality of spaced and opposed LED elements 410 in proximity with the head portion 402a of the plunger 402 when the plunger 402 is fully inserted into the slot 404. It should be noted that the LED elements 410 are mounted along side the whole edge of the head portion 402a and are controlled separately so that multi-split light messages can be provided (e.g. left hand side of the head portion 402a and at the same time, right hand side of the head portion 402a). Disposed below the bottom surface of the table top 408, there is provided an optional lock cam system 412 (e.g., a pair of spaced and opposed cam members 414, 416, respectively) that are selectively operable to engage a portion of a stem portion 402b of the plunger 402. In proximity to the lock cam system 412, is an optional pair of spaced and opposed LED elements 418, 420, respectively, which are in communication with an optional lighting/message system 422. In this manner, the various LED elements can communicate status and/or operational information to the lighting/message system 422, which in turn can be transmitted to the controller and/or other data storage or processing unit. Additionally, an optional empty sensor system 424 and/or paddle present sensor system 426 can be provided so as to detect the absence of the stem portion 402b or the presence of the stem portion 402a of the plunger 402, as the case may be. In this manner, the aforementioned sensors can, either alone or in combination with one another, function as a plunger status sensor system for sensing a plunger status condition consisting of the group of the plunger is fully inserted into the holding area, the plunger is partially inserted into the holding area, the plunger is not present in the holding area, and combinations thereof, wherein the plunger status sensor is selectively operable to transmit indicia of the plunger status condition (e.g., color coded and/or blinking lights) to the dealer or to a remote location.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A note validating and storage assembly for a gaming table, comprising:
a storage box for storing notes received at the gaming table, each note having an associated value;
a validator disposed adjacent to the storage box for validating the authenticity of the notes and determining the value of the notes,
a separator apparatus disposed adjacent to the validator for separating the notes;
a holding area operatively connected to the separator and configured for temporarily holding at least one note in a folded configuration; and
a fan assembly operably associated with the separator apparatus.

2. An assembly, as set forth in claim 1, wherein the fan assembly comprises at least one fan member.

3. An assembly, as set forth in claim 2, wherein the fan assembly comprises at least two fan members.

4. An assembly, as set forth in claim 3, wherein the at least two fan members are selectively operable to move air in a direction away from a stack of notes on a first conveyor system of the transport mechanism.

5. An assembly, as set forth in claim 4, wherein the fan assembly is angled such that a first end thereof is closer to the first conveyor system than a second spaced and opposed end thereof.

6. An assembly, as set forth in claim 5, wherein the at least two fan members are selectively operable to provide a flow of air towards the fan assembly.

7. An assembly, as set forth in claim 6, further comprising a second conveyor system located at a bottom end of the fan assembly.

8. An assembly, as set forth in claim 7, wherein the at least two fan members are selectively operable to draw air in a direction from the first conveyor towards the fan assembly, wherein the air flow lifts and separates the notes.

9. An assembly, as set forth in claim 8, further comprising a transport mechanism operatively connected between the separator apparatus and the validator for moving the note from the separator apparatus and through the validator.

10. An assembly, as set forth in claim 9, wherein the transport mechanism includes a first path operatively connected between the validator and the storage box for moving the note from the validator to the storage box.

11. An assembly, as set forth in claim 10, wherein the lifted note is moved in a direction towards the transport mechanism.

12. An assembly, as set forth in claim 11, further comprising a reject slot for returning notes for a reason selected from the group consisting of they are determined unauthentic by the validator, they are determined to be not fit enough by the validator, they are rejected by the dealer, they are rejected by a remote system, they are rejected by a local controller, and combinations thereof.

13. An assembly, as set forth in claim 12, wherein the transport mechanism further includes a second path operatively connected between the validator and the reject slot for moving the note from the validator to the reject slot.

14. An assembly, as set forth in claim 13, wherein the transport mechanism further includes a routing mechanism in operative communication with the validator for selecting between the first path and the second path in response to the authenticity of the note.

15. An assembly, as set forth in claim 1, further comprising a plunger for pushing the at least one note into the holding area and retaining the at least one note in the folded configuration.

16. An assembly, as set forth in claim 15, further comprising a note sensor disposed adjacent to the holding area for sensing at least one note in the holding area.

17. An assembly, as set forth in claim 16, further comprising a plunger status sensor disposed adjacent to the holding area for sensing a plunger status condition consisting of the group of the plunger is fully inserted into the holding area, the plunger is partially inserted into the holding area, the plunger is not present in the holding area, and combinations thereof, wherein the plunger status sensor is selectively operable to transmit indicia of the plunger status condition.

18. An assembly, as set forth in claim 17, further comprising a plunger lock disposed adjacent to the holding area and in operative communication with the note sensor and the plunger down sensor for locking the plunger in place in response to the note sensor sensing at least one note in the holding area and the plunger down sensor sensing that the plunger is fully inserted into the holding area.

19. An assembly, as set forth in claim 1, further comprising a controller in operative communication with the validator for receiving and storing data corresponding to the authenticity and value of the notes.

20. An assembly, as set forth in claim 19, further comprising a first transportable memory operatively connected to the storage box and in operative communication with the controller for recording the value of the notes stored in the storage box.

21. An assembly, as set forth in claim 20, wherein the first transportable memory is further defined as a first radio frequency identification (RFID) tag.

22. An assembly, as set forth in claim 21, further comprising a first RFID transceiver in operative communication with the controller for reading and writing data to the first RFID tag.

23. An assembly, as set forth in claim 19, further comprising a user interface in operative communication with the controller for allowing a user to communicate with the controller.

24. An assembly, as set forth in claim 23, wherein the user interface includes a card reader for reading an identification card.

25. An assembly, as set forth in claim 23, wherein the user interface includes a plurality of pushbuttons for entering data.

26. An assembly, as set forth in claim 25, wherein a portion of the pushbuttons are arranged to mirror player positions at the gaming table.

27. An assembly, as set forth in claim 23, wherein the user interface includes a display for displaying information to the user.

28. An assembly, as set forth in claim 23, wherein the user interface includes at least one indicating light for communicating status of the assembly to the user.

29. An assembly, as set forth in claim 23, wherein the user interface includes a biometric reader in operative communication with the controller for determining an identify of the user.

30. An assembly, as set forth in claim 19, further comprising an enclosure for enclosing the validator, the separator apparatus, and the holding area.

31. An assembly, as set forth in claim 30, wherein the storage box is removably attachable to the enclosure.

32. An assembly, as set forth in claim 30, further comprising a second transportable memory operatively connected to the enclosure and in operative communication with the controller.

33. An assembly, as set forth in claim 30, wherein the enclosure includes an enclosure door for accessing the contests of the enclosure.

34. An assembly, as set forth in claim 33, further comprising an enclosure door sensor in operative communication with the controller for sensing the position of the enclosure door.

35. An assembly, as set forth in claim 19, wherein the storage box includes a storage box door for accessing the contents of the storage box.

36. An assembly, as set forth in claim 35, further comprising a storage box door sensor in operative communication with the controller for sensing the position of the storage box door.

37. An assembly, as set forth in claim 19, further comprising a communications port in operative communications with said controller.

38. A chip validating and storage assembly for a gaming table, comprising:
a storage box for storing chips received at the gaming table, each chip having an associated value;
a validator disposed adjacent to the storage box for validating the authenticity of the chips and determining the value of the chips; and
a radio frequency identification system operably associated with the chip.

39. An assembly, as set forth in claim 38, wherein the radio frequency identification system is embedded in the chip.

40. An assembly, as set forth in claim 38, wherein the radio frequency identification system includes information about the associated value of the chip.

41. An assembly, as set forth in claim 38, wherein the radio frequency identification system includes information about a source of the chip.

42. An assembly, as set forth in claim 38, further comprising a transport mechanism selectively operable to move the chip to a storage box operably associated with the assembly.

43. An assembly, as set forth in claim 38, further comprising a radio frequency identification reader system that is selectively operable to read the information contained in the radio frequency identification system of the chip.

44. An assembly, as set forth in claim 43, further comprising a controller in operative communication with the radio frequency identification reader system for receiving and storing data corresponding to the authenticity and value of the chips.

45. An assembly, as set forth in claim 44, wherein the controller in selectively operable to tabulate the chips and the values associated therewith.

46. An assembly, as set forth in claim 45, wherein the controller is in operative communication with a central server.

47. An assembly, as set forth in claim 42, wherein information contained in the radio frequency identification system of the chip can be transmitted or stored on a first transportable memory operably associated with the storage box.

48. An assembly, as set forth in claim 47, wherein the first transportable memory is in operative communication with the controller for recording the value of the chips stored in the storage box.

49. An assembly, as set forth in claim 48, wherein the first transportable memory is further defined as a first radio frequency identification tag.

50. An assembly, as set forth in claim 49, further comprising a first radio frequency identification transceiver in operative communication with the controller for reading and writing data to the first radio frequency identification tag.

51. A note and chip validating and storage assembly for a gaming table, comprising:
a storage box system for storing notes and chips received at the gaming table, each note and chip having an associated value;
a validator disposed adjacent to the storage box system for validating the authenticity of the notes and chips and determining the value of the notes and chips;
a separator apparatus disposed adjacent to the validator for separating the notes;
a holding area operatively connected to the separator and configured for temporarily holding at least one note in a folded configuration;
a fan assembly operably associated with the separator apparatus; and
a radio frequency identification system operably associated with the chip.

52. An assembly, as set forth in claim 51, wherein the fan assembly comprises at least one fan member.

53. An assembly, as set forth in claim 52, wherein the fan assembly comprises at least two fan members.

54. An assembly, as set forth in claim 53, wherein the at least two fan members are selectively operable to move air in a direction away from a stack of notes on a first conveyor system of the transport mechanism.

55. An assembly, as set forth in claim 54, wherein the fan assembly is angled such that a first end thereof is closer to the first conveyor system than a second spaced and opposed end thereof.

56. An assembly, as set forth in claim 55, wherein the at least two fan members are selectively operable to provide a flow of air towards the fan assembly.

57. An assembly, as set forth in claim 56, further comprising a second conveyor system located at a bottom end of the fan assembly.

58. An assembly, as set forth in claim 57, wherein the at least two fan members are selectively operable to draw air in a direction from the first conveyor towards the fan assembly, wherein the air flow lifts and separates the notes.

59. An assembly, as set forth in claim 58, further comprising a transport mechanism operatively connected between the separator apparatus and the validator for moving the note from the separator apparatus and through the validator.

60. An assembly, as set forth in claim 59, wherein the transport mechanism includes a first path operatively connected between the validator and a note storage box for moving the note from the validator to the note storage box.

61. An assembly, as set forth in claim 60, wherein the lifted note is moved in a direction towards the transport mechanism.

62. An assembly, as set forth in claim 61, further comprising a reject slot for returning notes for a reason selected from the group consisting of they are determined unauthentic by the validator, they are determined to be not fit enough by the validator, they are rejected by the dealer, they are rejected by a remote system, they are rejected by a local controller, and combinations thereof.

63. An assembly, as set forth in claim 62, wherein the transport mechanism further includes a second path operatively connected between the validator and the reject slot for moving the note from the validator to the reject slot.

64. An assembly, as set forth in claim 63, wherein the transport mechanism further includes a routing mechanism in operative communication with the validator for selecting between the first path and the second path in response to the authenticity of the note.

65. An assembly, as set forth in claim 51, wherein the radio frequency identification system is embedded in the chip.

66. An assembly, as set forth in claim 51, wherein the radio frequency identification system includes information about the associated value of the chip.

67. An assembly, as set forth in claim 51, wherein the radio frequency identification system includes information about a source of the chip.

68. An assembly, as set forth in claim 51, further comprising a transport mechanism selectively operable to move the chip to a storage box operably associated with the assembly.

69. An assembly, as set forth in claim 51, further comprising a radio frequency identification reader system that is selectively operable to read the information contained in the radio frequency identification system of the chip.

70. An assembly, as set forth in claim 69, further comprising a controller in operative communication with the radio frequency identification reader system for receiving and storing data corresponding to the authenticity and value of the chips.

71. An assembly, as set forth in claim 70, wherein the controller in selectively operable to tabulate the chips and the values associated therewith.

72. An assembly, as set forth in claim 71, wherein the controller is in operative communication with a central server.

73. An assembly, as set forth in claim 68, wherein information contained in the radio frequency identification system of the chip can be transmitted or stored on a first transportable memory operably associated with a chip storage box.

74. An assembly, as set forth in claim 73, wherein the first transportable memory is in operative communication with the controller for recording the value of the chips stored in the chip storage box.

75. An assembly, as set forth in claim 74, wherein the first transportable memory is further defined as a first radio frequency identification tag.

76. An assembly, as set forth in claim 75, further comprising a first radio frequency identification transceiver in operative communication with the controller for reading and writing data to the first radio frequency identification tag.
